(19) United States
(12) Patent Application Publication
(10) Pub. No.: US 2024/0375235 A1
(43) Pub. Date: Nov. 14, 2024

(54) POLISHING DEVICE FOR INNER SURFACE OF PIPE

(71) Applicant: NEWASIA Co., Ltd., Yeoju-si (KR)

(72) Inventor: Sang Heon Lee, Seoul (KR)

(21) Appl. No.: 18/662,522

(22) Filed: May 13, 2024

(30) Foreign Application Priority Data
May 12, 2023 (KR) 10-2023-0061664

(51) Int. Cl. B24B 5/40; B08B 9/043

(52) U.S. Cl. CPC B24B 5/40; B08B 9/0433

(57) ABSTRACT

A polishing device for the inner surface of a pipe is disclosed. The polishing device for the inner surface of a pipe according to one aspect of the present invention includes a base plate; a polishing unit for polishing the inner surface of the pipe; a cleaning unit for cleaning the inner surface of the pipe whose inner surface has been polished through the polishing unit; a drying unit for drying the inner surface of the pipe whose inner surface has been cleaned through the cleaning unit; and a control unit for controlling the operation of each unit, wherein on the base plate, the polishing unit and the cleaning unit may be disposed, the polishing unit and the drying unit may be disposed, the cleaning unit and the drying unit may be disposed, or the polishing unit, the cleaning unit and the drying unit may be disposed.

### CROSS-REFERENCE TO RELATED APPLICATION

This application claims priority to and the benefit of Korean Patent Application No. 10-2023-0061664, filed on May 12, 2023, the disclosure of which is incorporated herein by reference in its entirety.

### TECHNICAL FIELD

The present invention relates to a polishing device, and more specifically to a polishing device for the inner surface of a pipe.

### BACKGROUND ART

The process of polishing the inner surface of a pipe using a conventional polishing device is carried out by placing an abrasive material installed at a front end of the rotation axis of a polishing motor inside the pipe and rotating the abrasive material while moving in the axial direction.

However, in the case of a long pipe, a round bar-shaped transmission shaft is provided that transmits a driving force between the rotation axis of the polishing motor and the abrasive material. When the driving force is transmitted by using a transmission shaft in this shape, there is a problem in that scratches are formed on the inner surface of a pipe by the vibration of the abrasive material by the rotation of the polishing motor.

In particular, as the length of the transmission shaft becomes longer, the vibration of the abrasive material increases. Therefore, when the pipe is formed to be longer than 6 m, there is a limitation in that it is difficult to polish at once due to this vibration problem.

In this case, an abrasive material is inserted into one side of the pipe to polish about 3 m of the pipe, and then, an abrasive material is inserted into the other side of the pipe to polish the remaining 3 m of the pipe. In this way, when the polishing work is performed intermittently, there is a problem in that poorly polished areas, such as unpolished areas where polishing is not performed in the central part of the pipe or poor roughness areas where the polishing roughness on both sides is different, are formed.

In addition, conventional polishing devices have a problem in that thermal deformation due to frictional heat occurs on the inner surface of the pipe due to the abrasive material rotating at high speed.

Moreover, after polishing the inner surface of the pipe, the inside of the pipe must be cleaned, but since conventional polishing devices are not provided with a configuration for cleaning the inside of the pipe, there is also the inconvenience of having to move the pipe to a separate space to clean the inside.

Furthermore, conventionally, the polished state of the inner surface of the pipe was inspected through a monitor with the operator's eyes or an endoscope, but when configured in this way, the judgment of the polished state of the inner surface of the pipe varies depending on the operator's skill level, and thus, there is a problem in that accurate judgment is difficult.

Therefore, there is a need for improvement in the above-mentioned problems.

### DISCLOSURE

### Technical Problem

The present invention has been devised to solve the above problems, and an object of the present invention is to provide a polishing device for the inner surface of a pipe in which scratches, poor polishing and thermal deformation do not occur on the inner surface of the pipe, it is possible to perform cleaning the inside of the pipe at once, and it is possible to accurately inspect even the polished state of the inner surface of the pipe.

The problems of the present invention are not limited to the problems mentioned above, and other problems that are not mentioned will be clearly understood by those skilled in the art from the description below.

### Technical Solution

According to an aspect of the present invention, provided is a polishing device for the inner surface of a pipe, including a base plate; a polishing unit for polishing the inner surface of the pipe; a cleaning unit for cleaning the inner surface of the pipe whose inner surface has been polished through the polishing unit; a drying unit for drying the inner surface of the pipe whose inner surface has been cleaned through the cleaning unit; and a control unit for controlling the operation of each unit, wherein on the base plate, the polishing unit and the cleaning unit are disposed, the polishing unit and the drying unit are disposed, the cleaning unit and the drying unit are disposed, or the polishing unit, the cleaning unit and the drying unit are disposed.

In this case, the polishing unit may include a first support member for supporting the pipe to form a downward slope; a polishing member for polishing the inner surface of the pipe; a polishing rod member for supporting the polishing member such that the polishing member is inserted into the interior of the pipe; and a polishing drive member for rotating the pipe supported by the first support member.

In this case, the polishing member may be provided in plurality along the axial direction.

In this case, the polishing member may include a polishing housing which is provided with a first flow path through which water is supplied, and a first outlet through which water supplied through the first flow path is sprayed to the outside; and an abrasive material which is combined to the polishing housing to polish the inner surface of the pipe.

In this case, the polishing housing may be provided with a coupling slot to which the abrasive material is combined.

In this case, the polishing member may further include an expansion tube which is disposed to surround a part of the outer surface of the polishing housing and expands outward in the radial direction when air is injected, and wherein the abrasive material is disposed to surround the outer surface of the expansion tube, and expands outward in the radial direction when the expansion tube expands.

In this case, the polishing housing may be provided with a second flow path through which air is supplied, and a second outlet which communicates with the second flow path such that the air supplied through the second flow path moves to an air chamber disposed between the outer surface of the polishing housing and the expansion tube.

In this case, the polishing housing may include a first polishing housing which is disposed at a front end in the axial direction, and a second polishing housing which is disposed rearward in the axial direction of the first polishing housing.

In this case, an end cap may be provided at a front end in the axial direction of the first polishing housing to close the inside and outside, and wherein a coupling thread is provided at a rear end in the axial direction of the first polishing housing.

In this case, coupling threads may be provided at the front end and rear end in the axial direction of the second polishing housing, and wherein the first flow path is disposed to penetrate along the axial direction of the second polishing housing.

In this case, the polishing unit may further include a connecting rod member which is disposed between the first polishing housing and the second polishing housing, wherein a first communication flow path is provided inside the connecting rod member to communicate the first flow path of the first polishing housing with the first flow path of the second polishing housing, and wherein the front end and rear end of the connecting rod member are respectively provided with corresponding threads that screw into the coupling threads.

In this case, the abrasive material may include a first abrasive material that primarily polishes the inner surface of the pipe, and a second abrasive material that secondarily polishes the primarily polished inner surface of the pipe.

In this case, the cleaning unit may include a second support member for supporting the pipe to form a downward slope; a spray member for spraying a fluid to clean the inner surface of the pipe; and a cleaning rod member for supporting the spray member such that the spray member is inserted into the interior of the pipe and supplies a fluid into the interior of the spray member.

In this case, the spray member may include a spray housing which is provided with a third flow path through which a fluid is supplied, and a third outlet through which the fluid that has been supplied through the third flow path is sprayed to the outside.

In this case, the control unit may control water to be sprayed first through the spray member and then the air to be sprayed.

In this case, the drying unit may include a third support member for supporting the pipe to form a downward slope; a drying member for spraying high-temperature air to dry the inner surface of the pipe; and a drying rod member for supporting the drying member such that the drying member is inserted into the pipe and supplies high-temperature air into the interior of the drying member.

In this case, the drying member may include a drying housing which is provided with a fourth flow path through which high-temperature air is supplied, and a fourth outlet through which the air supplied through the fourth flow path is sprayed to the outside.

In this case, the fourth outlet may be arranged such that a discharge slope is formed toward a front side in the axial direction.

In this case, the polishing device may further include a transfer unit for moving the pipe, wherein the control unit controls the transfer unit to sequentially move the pipe to the polishing unit, the washing unit and the drying unit.

In this case, the polishing device may further include an inspection unit for inspecting the polished state of the pipe whose inner surface has been dried through the drying unit.

According to another aspect of the present invention, provided is a polishing device for the inner surface of a pipe, including a base plate; a polishing unit which is disposed on one side of the base plate in the width direction to polish the inner surface of the pipe; a cleaning unit which is disposed on one side of the center of the base plate in the width direction to clean the inner surface of the pipe whose inner surface has been polished through the polishing unit; a drying unit which is disposed on the other side of the center of the base plate in the width direction to dry the inner surface of the pipe whose inner surface has been cleaned through the cleaning unit; an inspection unit which is disposed on the other side of the base plate in the width direction to inspect the polished state of the pipe whose inner surface has been dried through the drying unit; and a control unit for controlling the operation of each unit.

In this case, the inspection unit may include a fourth support member for supporting the pipe; a photographing member for photographing the inner surface of the pipe; an inspection rod member for supporting the photographing member such that the photographing member is inserted into the interior of the pipe; and an inspection drive member for rotating the pipe supported by the fourth support member.

### Advantageous Effects

According to the above configurations, the polishing device for the inner surface of a pipe according to one aspect of the present invention is capable of cleaning the pipe without moving the pipe to a separate space after polishing the inner surface of the pipe when the polishing unit and the cleaning unit are disposed on the base plate, and when the polishing unit and drying unit are disposed on the base plate, the pipe can be dried without having to move the pipe to a separate space after polishing the inner surface of the pipe. In addition, when the cleaning unit and drying unit are disposed on the base plate, the pipe can be dried without having to move the pipe to a separate space after cleaning the inner surface of the pipe. In addition, since the base plate is provided with a polishing unit for polishing the inner surface of the pipe, a cleaning unit for cleaning the inner surface of the pipe whose the inner surface has been polished, and a drying unit for drying the inner surface of the pipe whose the inner surface has been cleaned, it is possible to clean and dry pipes with polished inner surfaces without having to move the same to a separate space for cleaning, thereby improving workability.

In addition, as a plurality of polishing members are provided along the axial direction, the polishing rod member is stably supported and vibration does not occur in the polishing member, thereby allowing the pipe to be polished at once, and through this, since it is possible to shorten the process time, it can effectively inhibit scratches or polishing defects from forming on the inner surface of the pipe.

In addition, since water supplied through the polishing member is sprayed during polishing the inner surface of the pipe, it is possible to effectively inhibit thermal deformation due to frictional heat from occurring, even if high-speed relative rotation occurs between the polishing member and the pipe.

Moreover, the inspection unit for inspecting the polished state of the inner surface of the pipe is provided with a photographing member for photographing the inner surface of the pipe, and since the control unit inputs the photographed images into an AI learning model to determine the polished state of the inner surface of the pipe, it is possible to confirm the exact polished state of the inner surface of the pipe.

The effects of the present invention are not limited to the effects described above, and should be understood to include all effects that can be inferred from the configurations of the invention described in the detailed description or claims of the present invention.

### DESCRIPTION OF DRAWINGS

FIG. 1 is a plan view illustrating the polishing device for the inner surface of a pipe according to an exemplary embodiment of the present invention.

FIG. 2 is a side view of the polishing device for the inner surface of a pipe according to an exemplary embodiment of the present invention.

FIG. 3 is a configuration diagram of a polishing unit provided in the polishing device for the inner surface of a pipe according to an exemplary embodiment of the present invention.

FIG. 4 is a perspective view illustrating a polishing member provided the polishing device for the inner surface of a pipe according to an exemplary embodiment of the present invention.

FIG. 5 is a cross-sectional view of part I-I of FIG. 4.

FIG. 6 is a cross-sectional view of part II-II of FIG. 4.

FIG. 7 is a perspective view illustrating the first modified example of a polishing member provided in the polishing device for the inner surface of a pipe according to an exemplary embodiment of the present invention.

FIG. 8 is a cross-sectional view of part III-III of FIG. 7.

FIG. 9 is a perspective view illustrating the second modified example of a polishing member provided in the polishing device for the inner surface of a pipe according to an exemplary embodiment of the present invention.

FIG. 10 is a cross-sectional view of part IV-IV of FIG. 9.

FIG. 11 is a perspective view showing the third modified example of a polishing member provided in the polishing device for the inner surface of a pipe according to an exemplary embodiment of the present invention.

FIG. 12 is a cross-sectional view of part V-V of FIG. 11.

FIG. 13 is a cross-sectional view illustrating a connecting rod member provided in the polishing device for the inner surface of a pipe according to an exemplary embodiment of the present invention.

FIG. 14 is a cross-sectional view showing the modified example of a connecting rod member provided in the polishing device for the inner surface of a pipe according to an exemplary embodiment of the present invention.

FIG. 15 is a configuration diagram of a cleaning unit provided in the polishing device for the inner surface of a pipe according to an exemplary embodiment of the present invention.

FIG. 16 is a cross-sectional view illustrating a cleaning member provided in the polishing device for the inner surface of a pipe according to an exemplary embodiment of the present invention.

FIG. 17 is a configuration diagram of a drying unit provided in the polishing device for the inner surface of a pipe according to an exemplary embodiment of the present invention.

FIG. 18 is a cross-sectional view illustrating a drying member provided in the polishing device for the inner surface of a pipe according to an exemplary embodiment of the present invention.

FIG. 19 is a plan view illustrating the polishing device for the inner surface of a pipe according to another exemplary embodiment of the present invention.

FIG. 20 is a plan view illustrating the polishing device for the inner surface of a pipe according to another exemplary embodiment of the present invention.

FIG. 21 is a configuration diagram illustrating an inspection unit provided in the polishing device for the inner surface of a pipe according to another exemplary embodiment of the present invention.

### MODES OF THE INVENTION

Hereinafter, with reference to the attached drawings, the exemplary embodiments of the present invention will be described in detail so that those skilled in the art can easily practice the present invention. The present invention may be implemented in many different forms and is not limited to the exemplary embodiments described herein. In order to clearly describe the present invention, parts that are not relevant to the description have been omitted in the drawings, and the same or similar components are assigned the same reference numerals throughout the specification.

The words and terms used in the present specification and claims are not to be construed as limited in their usual or dictionary meanings, but according to the principle that the inventor can define terms and concepts in order to explain his or her invention in the best way, they must be interpreted with meanings and concepts that are consistent with the technical ideas of the present invention.

Therefore, the exemplary embodiments described in the present specification and the configurations illustrated in the drawings correspond to a preferred exemplary embodiment of the present invention, and do not represent the entire technical idea of the present invention, and thus, there may be various equivalents and modification examples to the corresponding configurations at the time of the filing of the present invention.

In the present specification, terms such as “include” or “have” are intended to describe the existence of features, numbers, steps, operations, components, parts or combinations thereof described in the specification, but it should be understood that the terms do not exclude the presence or possibility of addition of one or more other features, numbers, steps, operations, components, parts or combinations thereof.

Hereinafter, the polishing device for the inner surface of a pipe according to an exemplary embodiment of the present invention will be described with reference to the drawings.

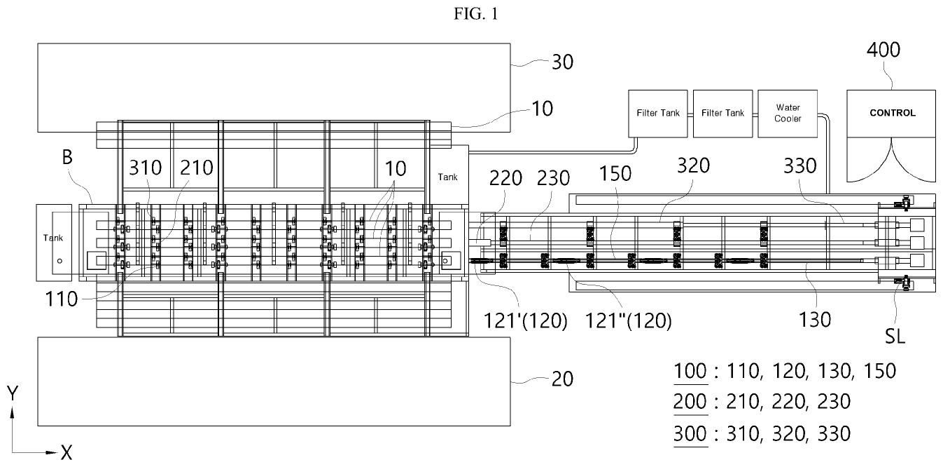

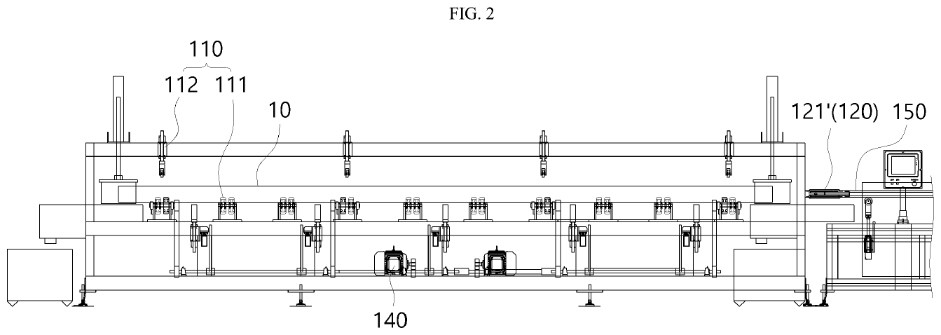

FIG. 1 is a plan view illustrating the polishing device for the inner surface of a pipe according to an exemplary embodiment of the present invention, and FIG. 2 is a side view of the polishing device for the inner surface of a pipe according to an exemplary embodiment of the present invention. Herein, the X direction means the longitudinal direction of the base plate, the Y direction means the width direction of the base plate, the a direction means the axial direction of the pipe, and the r direction means the radial direction of the pipe.

In general, piping and fittings through which high-purity solutions flow in semiconductor manufacturing facilities are made of stainless steel (316L), and the inner surface requires high purification and high precision, such as improving corrosion resistance through the removal of strained layers and corrosion-causing substances, as well as the roughness of the surface. To this end, as illustrated in FIG. 1, the polishing device for the inner surface of a pipe according to an exemplary embodiment of the present invention includes a base plate (B); a polishing unit 100 for polishing the inner surface of a pipe 10; a cleaning unit 200 for cleaning the inner surface of the pipe 10 whose inner surface has been polished through the polishing unit 100; a drying unit 300 for drying the inner surface of the pipe 10 whose inner surface has been cleaned through the cleaning unit 200; and a control unit 400 for controlling the operation of each unit, wherein on the base plate (B), the polishing unit 100 and the cleaning unit 200 are disposed, the polishing unit 100 and the drying unit 300 are disposed, the cleaning unit 200 and the drying unit 300 are disposed, or the polishing unit 100, the cleaning unit 200 and the drying unit 300 are disposed.

In this case, when the polishing unit 100 and the cleaning unit 200 are disposed on the base plate (B), the polishing unit 100 may be disposed on one side of the base plate (B) in the width direction (Y), and the cleaning unit 200 may be disposed on the other side of the base plate (B) in the width direction (Y). In this case, the drying unit 300 may be disposed separately at a location which is spaced apart from the base plate (B).

Alternatively, when the polishing unit 100 and the drying unit 300 are disposed on the base plate (B), the polishing unit 100 may be disposed on one side of the base plate (B) in the width direction (Y), and the drying unit 300 may be disposed on the other side of the base plate (B) in the width direction (Y). In this case, the cleaning unit 200 may be disposed separately at a location which is spaced apart from the base plate (B).

Alternatively, when the washing unit 200 and the drying unit 300 are disposed on the base plate (B), the washing unit 200 may be disposed on one side of the base plate (B) in the width direction (Y), and the drying unit 300 may be disposed on the other side of the base plate (B) in the width direction (Y). In this case, the polishing unit 100 may be disposed separately at a location which is spaced apart from the base plate (B).

Moreover, when the polishing unit 100, the cleaning unit 200 and the drying unit 300 are disposed on the base plate (B), the polishing unit 100 may be disposed on one side of the base plate (B) in the width direction (Y), the washing unit 200 may be disposed at the center of the base plate (B) in the width direction (Y), and the drying unit 300 may be disposed on the other side of the base plate (B) in the width direction (Y).

That is, when the polishing unit 100 and the cleaning unit 200 are disposed on the base plate (B), the pipe 10 may be cleaned without moving the pipe 10 to a separate space after polishing the inner surface of the pipe 10. In addition, when the polishing unit 100 and the drying unit 300 are disposed on the base plate (B), the pipe 10 may be dried without moving the pipe 10 to a separate space after polishing the inner surface of the pipe 10. In addition, when the cleaning unit 200 and the drying unit 300 are disposed on the base plate (B), the pipe 10 may be dried without moving the pipe 10 to a separate space after cleaning the inner surface of the pipe 10. In addition, since the base plate (B) is provided with a polishing unit 100 for polishing the inner surface of the pipe 10, as well as a cleaning unit 200 for cleaning the inner surface of the pipe 10 whose the inner surface has been polished and a drying unit 300 for drying the inner surface of the pipe 10 whose inner surface has been cleaned, the pipe 10 may be cleaned and dried without having to move the pipe 10 whose the inner surface has been polished to a separate space for cleaning, thereby improving workability.

In this case, a separate supply unit 20 for supplying the pipe 10 on the base plate (B), and a discharge unit 30 for discharging the pipe 10 that has been polished, cleaned and dried to the outside of the base plate (B) may be provided. That is, the pipe 10 which is supplied from the outside through the supply unit 20 is supplied in the width direction (Y) while being arranged along the longitudinal direction (X) of the base plate (B), and as it moves in the width direction (Y), it sequentially passes through the polishing unit 100, the cleaning unit 200 and the drying unit 300, and then, it is discharged to the outside of the base plate (B) through the discharge unit 30.

As described above, the polishing unit 100 may be disposed on one side of the base plate (B) in the width direction (Y), the washing unit 200 may be disposed in the center in the width direction (Y), and the drying unit 300 may be disposed on the other side in the width direction such that the pipe 10 sequentially passes through the polishing unit 100, the cleaning unit 200 and the drying unit 300 along the width direction (Y), but the present invention is not necessary limited thereto, and it is possible to change the arrangement order of the polishing unit 100, the cleaning unit 200 and the drying unit 300 on the base plate (B). However, in this way, even when the arrangement order of the polishing unit 100, cleaning unit 200 and drying unit 300 is changed, it is changed on the base plate (B), and thus, it is possible to clean and dry the pipe 10 without moving the pipe 10 whose inner surface has been polished to a separate space for cleaning, thereby improving workability.

In this case, as described below, the polishing device for the inner surface of a pipe according to an exemplary embodiment of the present invention may be provided with a separate tank that supplies water used when polishing the inner surface of the pipe 10, and such a tank supplies may include a supply tank for supplying water and a recovery tank for recovering water used in the polishing process. The water that has been recovered through the recovery tank is filtered by passing through a separate filter tank, and the filtered water is cooled through a water cooler and then may be used again for polishing the inner surface of the pipe 10. Additionally, this water may also be used to wash the inner surface of the pipe 10 whose inner surface has been polished.

As illustrated in FIGS. 1 and 2, the polishing unit 100 may include a first support member 110 for supporting the pipe 10 to form a downward slope; a polishing member 120 for polishing the inner surface of the pipe 10; a polishing rod member 130 for supporting the polishing member 120 such that the polishing member 120 is inserted into the interior of the pipe 10; and a polishing drive member 140 for rotating the pipe 10 supported by the first support member 110.

Such a first support member 110 supports the pipe 10 such that a downward slope is formed, and the downward slope is formed along a direction in which the polishing member 120 is inserted. When a downward slope is formed in the pipe 10 in this way, the water used during polishing the inner surface of the pipe 10 may flow along the slope and then be discharged to the outside of the pipe 10.

In this case, the first support member 110 may include a lower roller 111 and an upper roller 112. The lower roller 111 may support a lower part of the pipe 10, and the upper roller 112 may support an upper part of the pipe 10, and through this, it is possible to stably support the upper part and lower part of the pipe 10.

For the polishing member 120, a material which is capable of maximizing a grinding force in order to improve the polishing characteristics of the inner surface of the pipe 10 may be used. For example, a polishing member 120 that combines the properties of resin-bonded diamond and a non-woven fabric polishing wheel may be used, and through this combination, the inner surface of the pipe 10 may be uniformly polished, and at the same time, since less frictional heat is generated, the occurrence of defects due to thermal deformation may be minimized. Additionally, since less wear of the polishing member 120 occurs in the polishing process, the lifespan of the polishing member 120 is extended.

Such a polishing member 120 is inserted into the pipe 10 while being supported by the polishing rod member 130, and a slider (SL) may be provided to insert the polishing member 120 and the polishing rod member 130 into the pipe 10, or to move the polishing member 120 and the polishing rod member 130 in the axial direction (a) within the pipe 10. The slider (SL) may be provided in each of the polishing unit 100, the cleaning unit 200 and the drying unit 300, but it is also possible to use one slider (SL) for all of the polishing unit 100, cleaning unit 200 and drying unit 300.

In this case, the polishing drive member 140 is configured to rotate the pipe 10 which is supported by the first support member 110. As an example, the polishing drive member 140 may be configured to rotate the pipe 10 at a speed of 800 to 1,000 rpm. That is, when the polishing member 120 is inserted into the pipe 10 while being supported by the polishing rod member 130, the pipe 10 rotates and the polishing process on the inner surface of the pipe 10 begins, and the polishing rod member 130 continuously polishes the inner surface of the pipe 10 while moving the polishing member 120 in the axial direction (a). When configured in this way, vibration that occurs in the polishing rod member 130 may be minimized.

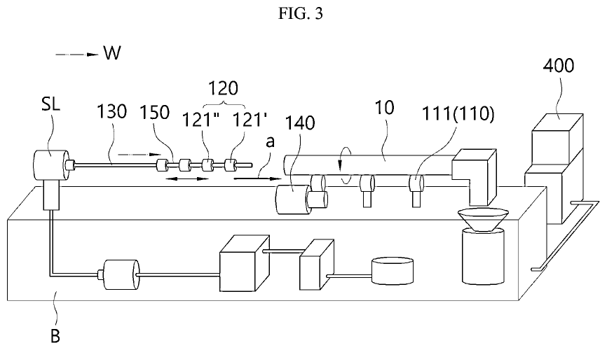

FIG. 3 is a configuration diagram of a polishing unit provided in the polishing device for the inner surface of a pipe according to an exemplary embodiment of the present invention.

As illustrated in FIG. 3, a plurality of polishing members 120 may be provided along the axial direction (a). In this way, as a plurality of polishing members 120 are provided along the axial direction (a), the polishing rod member 130 is stably supported, and vibration does not occur in the polishing member 120 such the pipe 10 can be polished once. Through this, the process time may be shortened, and the formation of scratches or defectively polished parts on the inner surface of the pipe 10 may be effectively inhibited.

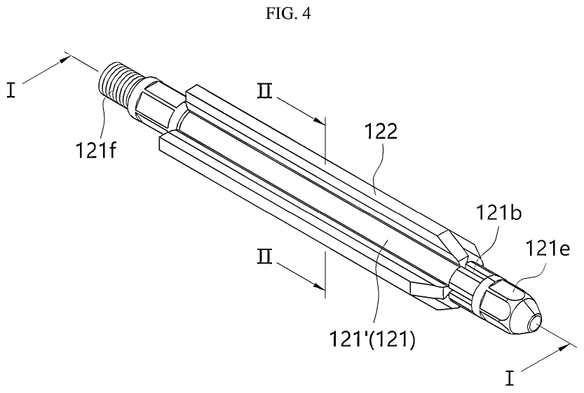

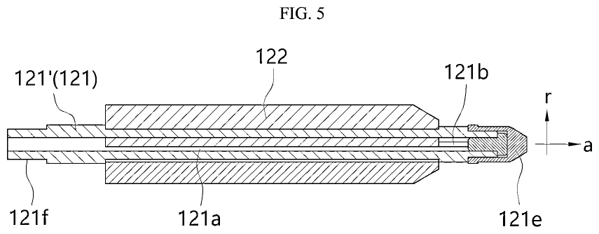

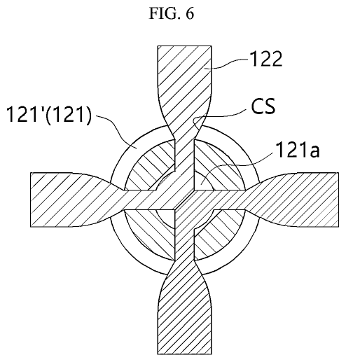

FIG. 4 is a perspective view illustrating a polishing member provided the polishing device for the inner surface of a pipe according to an exemplary embodiment of the present invention, FIG. 5 is a cross-sectional view of part I-I of FIG. 4, and FIG. 6 is a cross-sectional view of part II-II of FIG. 4.

As illustrated in FIG. 3, when polishing the inner surface of the pipe 10, water (W) is sprayed through the polishing member 120. To this end, as illustrated in FIGS. 4 to 6, the polishing member 120 may include a first flow path 121a through which water is supplied, a polishing housing 121 which is provided with a first outlet 121b through which water that has been supplied through the first flow path 121a is sprayed to the outside, and an abrasive material 122 which is coupled to the polishing housing 121 and polishes the inner surface of the pipe 10.

That is, since water supplied through the polishing member 120 is sprayed during polishing of the inner surface of the pipe 10, it is possible to effectively inhibit thermal deformation due to frictional heat from occurring, even if high-speed relative rotation occurs between the polishing member 120 and the pipe 10.

In this case, a water flow path through which water flows may be formed inside the polishing rod member 130 such that water is supplied to the first flow path 121a of the polishing member 120. Additionally, the polishing unit 100 may be provided with a pump that supplies water.

As illustrated in FIG. 6, the polishing housing 121 may be provided with a coupling slot (CS) to which the abrasive material 122 is coupled. This coupling slot (CS) may be formed to extend along the axial direction (a), and if the coupling slot (CS) is configured to be open only on one side in the axial direction (a), the abrasive material 122 may be easily installed by inserting the abrasive material 122 into one side of the axial direction (a), placing the same on the other side of the axial direction (a), and then closing one side of the axial direction (a) of the coupling slot (CS).

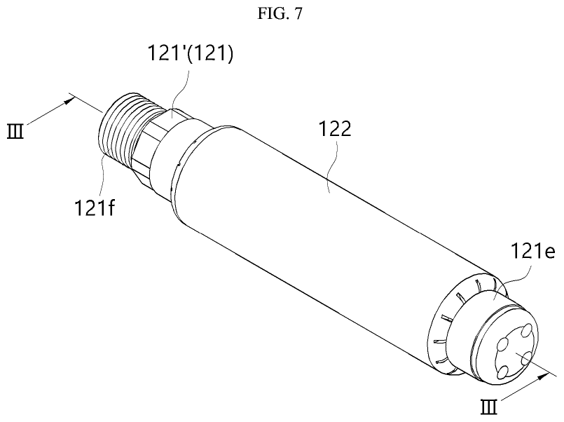

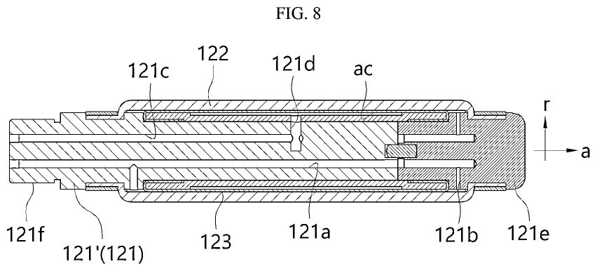

FIG. 7 is a perspective view illustrating the first modified example of a polishing member provided in the polishing device for the inner surface of a pipe according to an exemplary embodiment of the present invention, and FIG. 8 is a cross-sectional view of part III-III of FIG. 7.

As illustrated in FIGS. 7 and 8, the polishing member 120 is disposed to surround a part of the outer surface of the polishing housing 121, and further includes an expansion tube 123 that expands outward in the radial direction (r) when air is injected. Additionally, the abrasive material 122 is disposed to surround the outer surface of the expansion tube 123, and when the expansion tube 123 expands, it may expand outward in the radial direction (r).

That is, the abrasive material 122 is configured to expand or contract in the radial direction (r) through the expansion tube 123, and in the process of inserting the abrasive member 120 into the pipe 10, the abrasive material 122 is configured to maintain in a contracted state. After the polishing member 120 is inserted into the pipe 10, the abrasive material 122 is expanded in the radial direction (r) such that the abrasive material 122 presses the inner surface of the pipe 10, and then, the polishing process begins. Through this, effective polishing of the inner surface of the pipe 10 is possible.

As illustrated in FIG. 8, the polishing housing 121 may be provided with a second flow path 121c through which air is supplied, and a second outlet 121d which communicates with the second flow path 121c such that the air supplied through the second flow path 121c moves to an air chamber (ac) disposed between the outer surface of the polishing housing 121 and the expansion tube 123.

That is, the air supplied through the second flow path 121c moves to the air chamber (ac) disposed between the outer surface of the polishing housing 121 and the expansion tube 123 through the second outlet 121d, and when the air chamber (ac) is filled with air, the expansion tube 123 and the abrasive material 122 are configured to expand outward in the radial direction (r) such that the abrasive material 122 can be easily expanded.

In this case, an air flow path through which air flows may be formed inside the polishing rod member 130 such that air is supplied to the second flow path 121c of the polishing member 120.

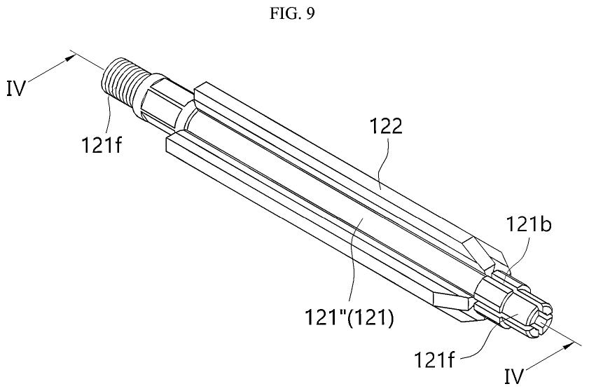

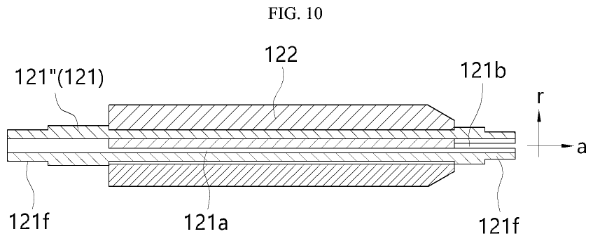

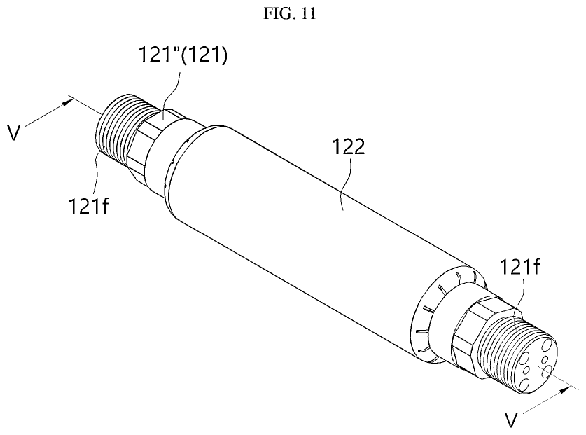

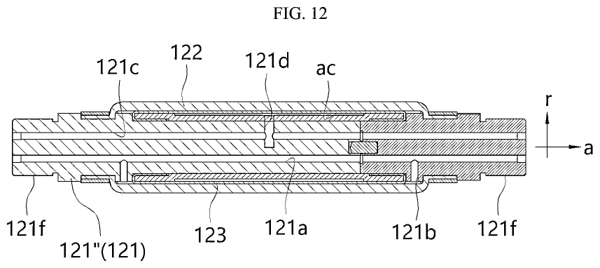

FIG. 9 is a perspective view illustrating the second modified example of a polishing member provided in the polishing device for the inner surface of a pipe according to an exemplary embodiment of the present invention, FIG. 10 is a cross-sectional view of part IV-IV of FIG. 9, FIG. 11 is a perspective view showing the third modified example of a polishing member provided in the polishing device for the inner surface of a pipe according to an exemplary embodiment of the present invention, and FIG. 12 is a cross-sectional view of part V-V of FIG. 11.

The polishing housing 121 may include a first polishing housing 121′ which is disposed at a front end in the axial direction (a), as illustrated in FIGS. 5 and 7, and a second polishing housing 121″ which is disposed rearward in the axial direction (a) of the first polishing housing 121′, as illustrated in FIGS. 9 and 11.

That is, it is configured such that the first polishing housing 121′ is disposed at the front end along the axial direction (a) of the pipe 10, and the second polishing housing 121″ is sequentially disposed rearward. When configured in this way, the polishing rod member 130 is stably supported, and vibration does not occur in the polishing member 120 such that the pipe 10 can be polished at once, and through this, it is possible to shorten the process time, and the pipe 10, and it is possible to effectively inhibit the formation of scratches or defectively polished parts on the inner surface of the pipe 10.

As illustrated in FIGS. 5 and 7, an end cap 121e may be provided at a front end in the axial direction (a) of the first polishing housing 121′ to close the inside and the outside, and a coupling thread 121f may be provided at a rear end in the axial direction (a) of the first polishing housing 121′.

That is, since the end cap 121e is provided at the front end in the axial direction (a) of the first polishing housing 121′, the water or air supplied inside is inhibited from being arbitrarily discharged to the front end in the axial direction (a) of the first polishing housing 121′, and it is possible to inhibit the arbitrary separation of the abrasive material 122.

In addition, since a coupling thread 121f is provided at the rear end in the axial direction (a) of the first polishing housing 121′, it is possible to simply connect the connecting rod member 150, which will be described below.

As illustrated in FIGS. 10 and 12, coupling threads 121f may be provided at the front and rear ends in the axial direction (a) of the second polishing housing 121″. That is, a coupling thread 121f is provided at a front end in the axial direction (a) of the second polishing housing 121″ to enable simple connection to the connecting rod member 150, which will be described below, and a coupling thread 121f is also provided at a rear end in the axial direction (a) of the second polishing housing 121″ so as to be simply connected to the connecting rod member 150 or the polishing rod member 130.

In this case, as illustrated in FIGS. 10 and 12, the first flow path 121a through which water is supplied may be disposed to penetrate along the axial direction (a) of the second polishing housing 121″, and through this, it is possible to supply water up to the first polishing housing 121′. In addition, as illustrated in FIG. 12, the second flow path 121c through which air is supplied may be disposed to penetrate along the axial direction (a) of the second polishing housing 121″, and through this, it is possible to supply air up to the first polishing housing 121′.

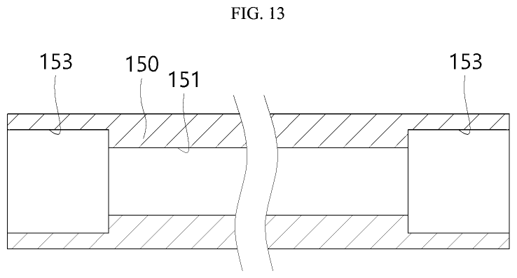

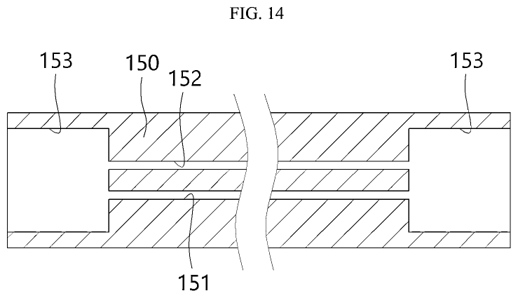

FIG. 13 is a cross-sectional view illustrating a connecting rod member provided in the polishing device for the inner surface of a pipe according to an exemplary embodiment of the present invention, and FIG. 14 is a cross-sectional view showing the modified example of a connecting rod member provided in the polishing device for the inner surface of a pipe according to an exemplary embodiment of the present invention.

As illustrated in FIGS. 13 and 14, the polishing unit 100 may further include a connecting rod member 150 which is disposed between the first polishing housing 121′ and the second polishing housing 121″, and a first communication passage 151 may be provided inside the connecting rod member 150 which communicates the first flow path 121a of the first polishing housing 121′ with the first flow path 121a of the second polishing housing 121″.

That is, a connecting rod member 150 may be provided between the first polishing housing 121′ and the second polishing housing 121″, and water flowing through the first flow path 121a of the second polishing housing 121″ is supplied to the first flow path 121a of the first polishing housing 121′ through the first communication flow path 151 of the connecting rod member 150/

In addition, as illustrated in FIG. 14, it may be configured such that air flowing through the second flow path 121c of the second polishing housing 121″ is supplied to the second flow path 121c of the first polishing housing 121′ through the second communication flow path 152 of the connecting rod member 150.

Moreover, the front end and the rear end of the connecting rod member 150 may each be provided with a corresponding thread 153 that is screwed to the coupling thread 121f, and through this, the first polishing housing 121′, the connecting rod member 150 and the second polishing housing 121″ may be easily connected.

In this case, the above-described abrasive material 122 may include a first abrasive material that primarily polishes the inner surface of the pipe 10, and a second abrasive material that secondarily polishes the primarily polished inner surface of the pipe 10. That is, the inner surface of the pipe 10 is primarily polished by using the first abrasive material, and the primarily polished inner surface of the pipe 10 is secondarily polished by using the second abrasive material. The first abrasive material and the second abrasive material may be constituted by different materials. For example, the first abrasive material may be a porous pad material, and the second abrasive material may be a polishing pad.

In addition, the polishing unit 100 may include a primary polishing unit which is provided with a polishing housing 121 to which the first abrasive material is combined, and a secondary polishing unit which is provided with a polishing housing 121 to which the second abrasive is combined. That is, the inner surface of the pipe 10 is primarily polished through the primary polishing unit, and the primarily polished inner surface of the pipe 10 is secondarily polished through the secondary polishing unit.

In addition, a cleaning process through the cleaning unit 200 may be added between primary polishing through the first polishing unit and secondary polishing through the second polishing unit. That is, a primary polishing process through the first polishing unit, a cleaning process through the cleaning unit 200, a secondary polishing process through the second polishing unit, a cleaning process through the cleaning unit 200, and a drying process through the drying unit 300 may proceed sequentially.

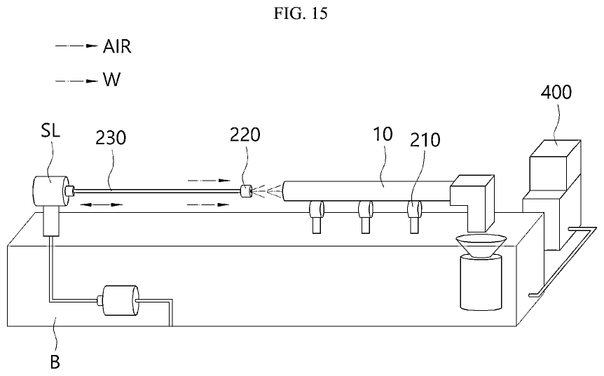

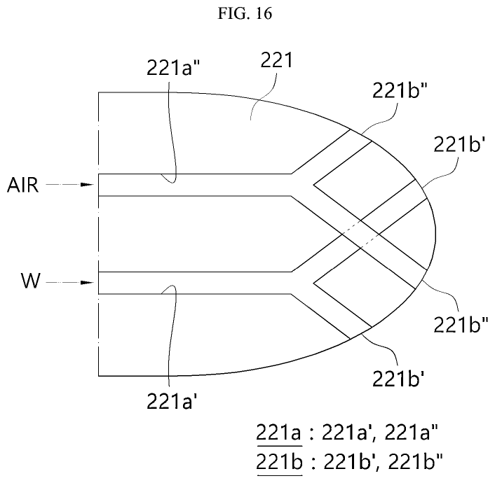

FIG. 15 is a configuration diagram of a cleaning unit provided in the polishing device for the inner surface of a pipe according to an exemplary embodiment of the present invention, and FIG. 16 is a cross-sectional view illustrating a cleaning member provided in the polishing device for the inner surface of a pipe according to an exemplary embodiment of the present invention.

As illustrated in FIGS. 15 and 16, the cleaning unit 200 may include a second support member 210 for supporting the pipe 10 to form a downward slope; a spray member 220 for spraying a fluid to clean the inner surface of the pipe 10; and a cleaning rod member 230 for supporting the spray member 220 such that the spray member 220 is inserted into the interior of the pipe 10 and supplies a fluid into the interior of the spray member 220.

Such a second support member 210 supports the pipe 10 such that a downward slope is formed, and the downward slope is formed along a direction in which the spray member 220 is inserted. When a downward slope is formed in the pipe 10 in this way, the water used to clean the inner surface of the pipe 10 may flow along the slope and then be discharged to the outside of the pipe 10.

Such a spray member 220 is inserted into the pipe 10 while being supported by the cleaning rod member 230, and a slider (SL) may be provided to insert the spray member 220 and the cleaning rod member 230 into the pipe 10 or to move the spray member 220 and the cleaning rod member 230 in the axial direction (a) within the pipe 10. Sliders (SL) may be respectively provided in the polishing unit 100, the cleaning unit 200 and the drying unit 300, but it is also possible to use one slider (SL) for all of the polishing unit 100, the cleaning unit 200 and the drying unit 300.

As illustrated in FIG. 15, water (W) and air (AIR) are sequentially sprayed through the spray member 220 to clean the inner surface of the pipe 10. To this end, as illustrated in FIG. 16, the spray member 220 may include a spray housing 221 which is provided with a third flow path 221a through which a fluid is supplied, and a third outlet 221b through which the fluid supplied through the third flow path 221a is sprayed to the outside. In this case, the third flow path 221a may include a third water flow path 221a′ through which water (W) is supplied, and a third air flow path 221a″ through which air (AIR) is supplied. Additionally, the third outlet 221b may include a third water outlet 221b′ through which water (W) is sprayed to the outside, and a third air outlet 221b″ through which air (AIR) is sprayed to the outside.

That is, it is configured such that water is first sprayed into the pipe 10 to primarily clean the same, and then high-pressure air is additionally sprayed to secondarily clean the same. In order to spray water, the water supplied from the outside of the spray housing 221 flows through the third water flow path 221a′ and is then sprayed into the pipe 10 through the third water outlet 221b′, and in order to spray air, air supplied from the outside of the spray housing 221 flows through the third air passage 221a″ and is then sprayed into the pipe 10 through the third air outlet 221b″.

To this end, the washing unit 200 may be provided with a pump that supplies water and a compressor that supplies high-pressure air.

As illustrated in FIG. 15, the control unit 400 may control water (W) to be sprayed first through the spray member 220 and then air (AIR) to be sprayed. When configured in this way, it is possible to first clean the inner surface of the pipe 10 by using water and then discharge all of the water used for cleaning by using high-pressure air.

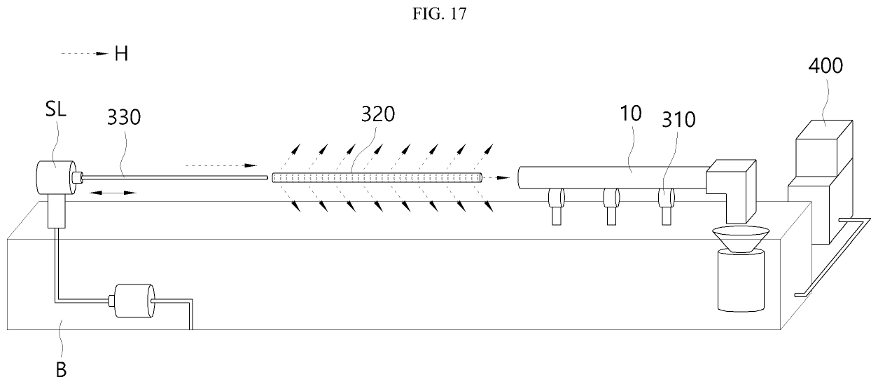

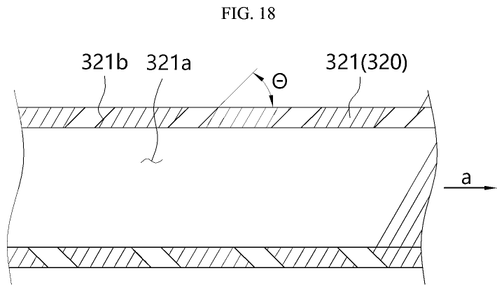

FIG. 17 is a configuration diagram of a drying unit provided in the polishing device for the inner surface of a pipe according to an exemplary embodiment of the present invention, and FIG. 18 is a cross-sectional view illustrating a drying member provided in the polishing device for the inner surface of a pipe according to an exemplary embodiment of the present invention.

As illustrated in FIGS. 17 and 18, the drying unit 300 may include a third support member 310 for supporting the pipe 10 to form a downward slope; a drying member 320 for spraying high-temperature air to dry the inner surface of the pipe 10; and a drying rod member 330 for supporting the drying member 320 such that the drying member 320 is inserted into the pipe 10 and supplies high-temperature air into the interior of the drying member 320.

Such a third support member 310 supports the pipe 10 such that a downward slope is formed, and the downward slope is formed along a direction in which the drying member 320 is inserted. In this way, when a downward slope is formed in the pipe 10, the remaining water used when cleaning the inner surface of the pipe 10 is pushed in the axial direction (a) by the high-temperature air sprayed through the drying member 320, and after flowing along the slope, it may be discharged to the outside of the pipe 10.

Such a drying member 320 is inserted into the pipe 10 while being supported by the drying rod member 330, and a slider (SL) may be provided to insert the drying member 320 and the drying rod member 330 into the pipe 10 or to move the drying member 320 and the drying rod member 330 in the axial direction (a) within the pipe 10. The slider (SL) may be provided in each of the polishing unit 100, the cleaning unit 200 and the drying unit 300, but it is also possible to use one slider (SL) for all of the polishing unit 100, cleaning unit 200 and drying unit 300.

As illustrated in FIG. 18, the drying member 320 may include a drying housing 321 which is provided with a fourth flow path 321a through which high-temperature air is supplied, and a fourth outlet 321b through which the air supplied through the fourth flow path 321a is sprayed to the outside.

A plurality of fourth outlets 321b may be arranged along the peripheral direction of the drying housing 321, and the fourth outlets 321b may be arranged in multiple rows along the axial direction (a) of the drying housing 321.

That is, it is configured such that the inside of the pipe 10 is dried by spraying high-temperature air into the pipe 10 through the drying housing 321. To this end, the drying unit 300 may be provided with a heating member and a blowing member which are capable of generating high-temperature air such as hot air, and through this, the generated high-temperature air may be transferred through the drying rod member 330 to the drying member 320.

As illustrated in FIG. 18, the fourth outlet 321b may be arranged such that the discharge slope (Θ) is formed toward a front side in the axial direction (a). In this way, when the discharge slope (Θ) is formed at the fourth outlet 321b which is provided in the drying housing 321, the remaining water used when cleaning the inner surface of the pipe 10 may be pushed in the axial direction (a) by high-temperature air sprayed through the drying member 320 and then discharged to the outside of the pipe 10.

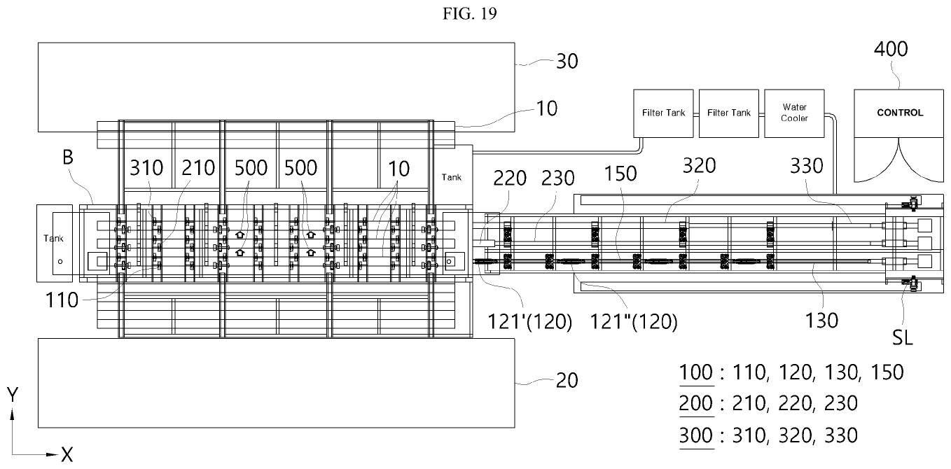

FIG. 19 is a plan view illustrating the polishing device for the inner surface of a pipe according to another exemplary embodiment of the present invention.

As illustrated in FIG. 19, the polishing device further includes a transfer unit 500 for moving the pipe 10, and the control unit 400 may control the transfer unit 500 such that the pipe 10 sequentially moves to the polishing unit 100, the washing unit 200 and the drying unit 300.

That is, when the pipe 10 is supplied to the polishing unit 100 through the above-described supply unit 20, a polishing process on the inner surface of the pipe 10 is performed in the polishing unit 100, and when the polishing process is completed, the pipe 10 moves from the polishing unit 100 to the cleaning unit 200 through the transfer unit 500. In addition, when the cleaning process is completed in the cleaning unit, the pipe 10 moves from the washing unit 200 to the drying unit 300 through the transfer unit 500. When the drying process of the pipe 10 is completed in the drying unit 300, it is discharged to the outside through the discharge unit 30.

In this case, the transfer unit 500 may include not only a configuration that automatically moves the pipe 10 using the control unit 400, but also a configuration that allows the operator to manually move the pipe 10 using a separate tool. Furthermore, the operator may directly move the pipe 10 by hand without a separate transfer unit 500.

In this case, the polishing device may further include an inspection unit 600 for inspecting the polished state of the pipe 10 whose inner surface has been dried through the drying unit 300. Through such an inspection unit 600, the inner polished state of the pipe 10 whose the inner surface has been dried may be inspected, thereby enabling accurate inspection. The control unit 400 inspects the polished state of the inner surface of the pipe 10 through an image of the inner surface of the pipe 10 photographed through a photographing member 620, which will be described below, and the polished state of the inner surface of the pipe 10 may be roughness, scratches, star burst (tearing), heat deformation and the like.

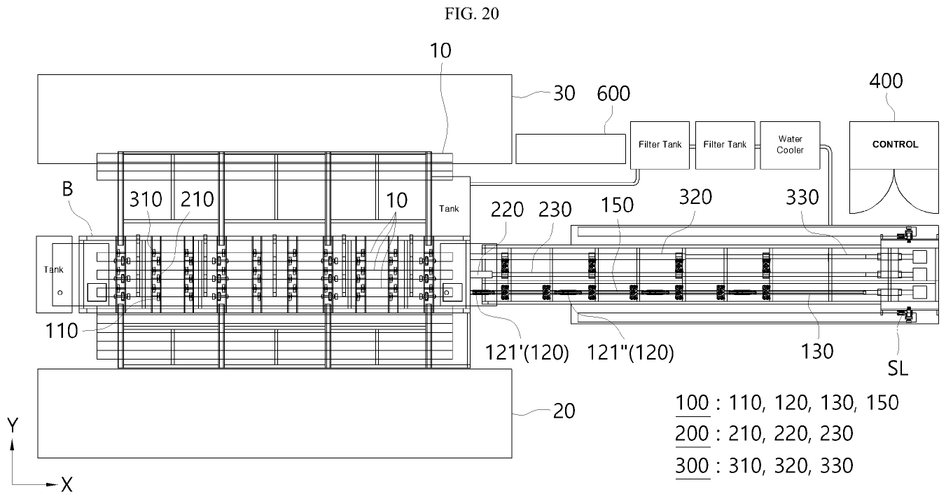

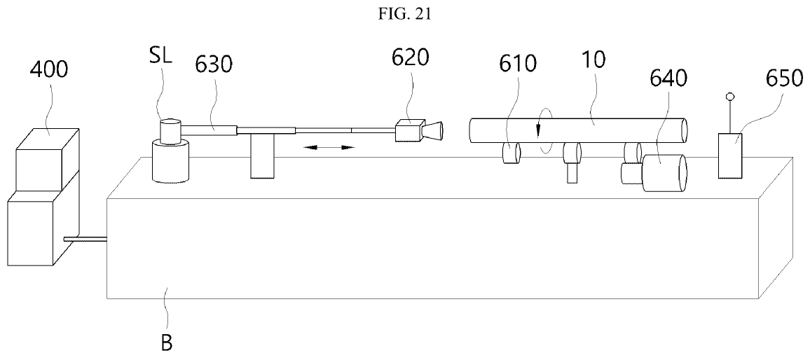

FIG. 20 is a plan view illustrating the polishing device for the inner surface of a pipe according to another exemplary embodiment of the present invention, and FIG. 21 is a configuration diagram illustrating an inspection unit provided in the polishing device for the inner surface of a pipe according to another exemplary embodiment of the present invention.

As illustrated in FIG. 20, the polishing device according to another exemplary embodiment of the present invention includes a base plate (B); a polishing unit 100 which is disposed on one side of the base plate (B) in the width direction (Y) to polish the inner surface of the pipe 10; a cleaning unit 200 which is disposed on one side of the center of the base plate (B) in the width direction (Y) to clean the inner surface of the pipe 10 whose inner surface has been polished through the polishing unit 100; a drying unit 300 which is disposed on the other side of the center of the base plate (B) in the width direction (Y) to dry the inner surface of the pipe 10 whose inner surface has been cleaned through the cleaning unit 200; an inspection unit 600 which is disposed on the other side of the base plate (B) in the width direction (Y) to inspect the polished state of the pipe 10 whose inner surface has been dried through the drying unit 300; and a control unit 400 for controlling the operation of each unit.

That is, since the base plate (B) is provided with not only a polishing unit 100 for polishing the inner surface of the pipe 10, but also a cleaning unit 200 for cleaning the inner surface of the pipe 10 whose inner surface has been polished, a drying unit for drying the inner surface of the pipe 10 whose inner surface has been washed and an inspection unit 600 for inspecting the polished state of the dried pipe 10, it is possible to clean and dry the pipe 10 without having to move the pipe 10, whose inner surface has been polished, to a separate space for cleaning, thereby improving workability, and since it is possible to inspect the polished state of the inner surface of the pipe 10 whose inner surface has been dried through the inspection unit 600, accurate inspection is possible.

In this case, the control unit 400 inspects the polished state of the inner surface of the pipe 10 through an inner image of the pipe 10 photographed through the photographing member 620, and the polished state of the inner surface of the pipe 10 may be roughness, scratches, star burst (tearing), heat deformation and the like.

As illustrated in FIG. 21, the inspection unit 600 may include a fourth support member 610 for supporting the pipe 10; a photographing member 620 for photographing the inner surface of the pipe 10; an inspection rod member 630 for supporting the photographing member 620 such that the photographing member 620 is inserted into the interior of the pipe 10; and an inspection drive member 640 for rotating the pipe 10 supported by the fourth support member 610.

That is, when the pipe 10 is supported through the fourth support member 610, the photographing member 620 is inserted into the pipe 10 while being supported by the inspection rod member 630, and a slider (SL) may be provided to insert the photographing member 620 and the inspection rod member 630 into the pipe 10 or to move the photographing member 620 and the inspection rod member 630 in the axial direction (a) within the pipe 10. The slider (SL) may be respectively provided in the polishing unit 100, the cleaning unit 200, the drying unit 300 and the inspection unit 600, but it is also possible to use one slider (SL) for all of the polishing unit 100, the cleaning unit 200, the drying unit 300 and the inspection unit 600.

In this way, the inspection unit 600, which inspects the polished state of the inner surface of the pipe 10, is provided with the photographing member 620 to photograph the inner surface of the pipe, and since the control unit 400 inputs the photographed image into an AI learning model to determine the polished state of the inner surface of the pipe 10, the exact polished state of the inner surface of the pipe 10 may be confirmed. In addition, data on the polished state of the pipe 10 photographed through the photographing member 620 is fed back through the control unit 400, thereby allowing the polished state of the pipe 10 to be further improved.

Such an inspection unit 600 may be provided with an additional sensor 650 that inspects the inner state of the pipe 10.

As reviewed above, since the base plate (B) provided in the polishing device for the inner surface of a pipe according to an exemplary embodiment of the present invention is provided with not only the polishing unit 100 for polishing the inner surface of the pipe 10, but also the cleaning unit 200 for cleaning the inner surface of the pipe 10 whose inner surface has been polished and the drying unit 300 for drying the inner surface of the pipe 10 whose inner surface has been cleaned, it is possible to clean and dry the pipe 10 without having to move the pipe 10, whose inner surface has been polished, to a separate space for cleaning, thereby improving workability.

Although one exemplary embodiment of the present invention has been described above, the spirit of the present invention is not limited to the exemplary embodiments presented in the present specification, and those skilled in the art who understand the spirit of the present invention may easily suggest other exemplary embodiments by changing, modifying, deleting or adding components within the scope of the same spirit, but this will also fall within the scope of the present invention.

### EXPLANATION OF REFERENCE NUMERALS

10: Pipe
20: Supply unit
30: Discharge unit
100: Polishing unit
110: First support member
111: Lower roller
112: Upper roller
120: Polishing member
121: Polishing housing
121′: First polishing housing
121″: Second polishing housing
121a: First flow path
121b: First outlet
121c: Second flow path
121d: Second outlet
121e: End cap
121f: Coupling thread
122: Abrasive material
123: Expansion tube
130: Polishing rod member
140: Polishing drive member
150: Connecting rod member
151: First communication flow path
152: Second communication flow path
153: Corresponding thread
200: Cleaning unit
210: Second support member
220: Spray member
221: Spray housing
221a: Third flow path
221a′: Third water flow path
221a″: Third air flow path
221b: Third outlet
221b′: Third water outlet
221b″: Third air outlet
230: Cleaning rod member
300: Drying unit
310: Third support member
320: Drying member
321: Drying housing
321a: Fourth flow path
321b: Fourth outlet
330: Drying rod member
400: Control unit
500: Transfer unit
600: Inspection unit
610: Fourth support member
620: Photographing member
630: Inspection rod member
640: Inspection drive member
650: Sensor
ac: Air chamber
B: Base plate
CS: Coupling slot
SL: Slider
Θ: Discharge slope
a: Axial direction
r: Radial direction
X: Longitudinal direction
Y: Width direction

1. A polishing device for an inner surface of a pipe, comprising:
a base plate;
a polishing unit configured to polish the inner surface of the pipe;
a cleaning unit configured to clean the inner surface of the pipe whose inner surface has been polished by the polishing unit;
a drying unit configured to dry the inner surface of the pipe whose inner surface has been cleaned by the cleaning unit; and
a control unit configured to control the operation of each unit,
wherein on the base plate, the polishing unit and the cleaning unit are disposed, the polishing unit and the drying unit are disposed, the cleaning unit and the drying unit are disposed, or the polishing unit, the cleaning unit and the drying unit are disposed.

2. The polishing device of claim 1, wherein the polishing unit comprises:
a first support member configured to support the pipe to form a downward slope;
a polishing member configured to polish the inner surface of the pipe;
a polishing rod member configured to support the polishing member such that the polishing member is inserted into the interior of the pipe; and
a polishing drive member configured to rotate the pipe supported by the first support member.

3. The polishing device of claim 2, wherein the polishing member is provided in plurality along an axial direction.

4. The polishing device of claim 3, wherein the polishing member comprises:
a polishing housing that is provided with a first flow path through which water is supplied, and a first outlet through which water supplied through the first flow path is sprayed to an outside; and
an abrasive material that is combined with the polishing housing and configured to polish the inner surface of the pipe.

5. The polishing device of claim 4, wherein the polishing housing is provided with a coupling slot to which the abrasive material is combined.

6. The polishing device of claim 4, wherein the polishing member further comprises an expansion tube that is disposed to surround a part of an outer surface of the polishing housing and to expand outward in a radial direction when air is injected, and
wherein the abrasive material is disposed to surround an outer surface of the expansion tube and to expand outward in the radial direction when the expansion tube expands.

7. The polishing device of claim 6, wherein the polishing housing is provided with a second flow path through which air is supplied, and a second outlet that communicates with the second flow path such that the air supplied through the second flow path moves to an air chamber disposed between the outer surface of the polishing housing and the expansion tube.

8. The polishing device of claim 4, wherein the polishing housing comprises a first polishing housing that is disposed at a front end in the axial direction, and a second polishing housing that is disposed rearward in the axial direction of the first polishing housing.

9. The polishing device of claim 8, wherein an end cap is provided at a front end in the axial direction of the first polishing housing to close the inside and outside, and
wherein a coupling thread is provided at a rear end in the axial direction of the first polishing housing.

10. The polishing device of claim 9, wherein coupling threads are provided at a front end and a rear end in the axial direction of the second polishing housing, and
wherein the first flow path is disposed to penetrate along the axial direction of the second polishing housing.

11. The polishing device of claim 10, wherein the polishing unit further comprises a connecting rod member that is disposed between the first polishing housing and the second polishing housing,
wherein a first communication flow path is provided inside the connecting rod member to communicate the first flow path of the first polishing housing with the first flow path of the second polishing housing, and
wherein a front end and a rear end of the connecting rod member are respectively provided with corresponding threads that screw into the coupling threads.

12. The polishing device of claim 4, wherein the abrasive material comprises a first abrasive material configured to primarily polish the inner surface of the pipe, and a second abrasive material configured to secondarily polish the primarily polished inner surface of the pipe.

13. The polishing device of claim 1, wherein the cleaning unit comprises:
a second support member configured to support the pipe to form a downward slope;
a spray member configured to spray a fluid to clean the inner surface of the pipe; and
a cleaning rod member configured to support the spray member such that the spray member is inserted into an interior of the pipe and configured to supply a fluid into an interior of the spray member.

14. The polishing device of claim 13, wherein the spray member comprises a spray housing that is provided with a third flow path through which a fluid is supplied, and a third outlet through which the fluid that has been supplied through the third flow path is sprayed to an outside.

15. The polishing device of claim 14, wherein the control unit controls water to be sprayed first through the spray member and then the air to be sprayed.

16. The polishing device of claim 1, wherein the drying unit comprises:
a third support member configured to support the pipe to form a downward slope;
a drying member configured to spray high-temperature air to dry the inner surface of the pipe; and
a drying rod member configured to support the drying member such that the drying member is inserted into the pipe and supplies high-temperature air into an interior of the drying member.

17. The polishing device of claim 16, wherein the drying member comprises a drying housing that is provided with a fourth flow path through which high-temperature air is supplied, and a fourth outlet through which the air supplied through the fourth flow path is sprayed to an outside.

18. The polishing device of claim 17, wherein the fourth outlet is arranged such that a discharge slope is formed toward a front side in an axial direction.

19. The polishing device of claim 1, further comprising:
a transfer unit configured to move the pipe,
wherein the control unit controls the transfer unit to sequentially move the pipe to the polishing unit, the washing unit, and the drying unit.

20. The polishing device of claim 1, further comprising:
an inspection unit configured to inspect a polished state of the pipe whose inner surface has been dried by the drying unit.

21. A polishing device for an inner surface of a pipe, comprising:
a base plate;
a polishing unit that is disposed on one side of the base plate in a width direction and configured to polish the inner surface of the pipe;
a cleaning unit that is disposed on one side of a center of the base plate in the width direction and configured to clean the inner surface of the pipe whose inner surface has been polished by the polishing unit;
a drying unit that is disposed on an other side of the center of the base plate in the width direction and configured to dry the inner surface of the pipe whose inner surface has been cleaned by the cleaning unit;
an inspection unit that is disposed on the other side of the center of the base plate in the width direction to inspect the polished state of the pipe whose inner surface has been dried by the drying unit; and
a control unit configured to control the operation of each unit.

22. The polishing device of claim 21, wherein the inspection unit comprises:
a fourth support member configured to support the pipe;
a photographing member configured to photograph the inner surface of the pipe;
an inspection rod member configured to support the photographing member such that the photographing member is inserted into an interior of the pipe; and
an inspection drive member configured to rotate the pipe supported by the fourth support member.
